(19) United States
(12) Patent Application Publication
(10) Pub. No.: US 2025/0261021 A1
(43) Pub. Date: Aug. 14, 2025

(54) User Equipment Operation for Inter-Cell L1-RSRP Measurements

(71) Applicant: Apple Inc., CUPERTINO, CA (US)

(72) Inventors: Manasa RAGHAVAN, Sunnyvale, CA (US); Jie CUI, San Jose, CA (US); Yang TANG, San Jose, CA (US); Qiming LI, Beijing (CN); Xiang CHEN, Palo Alto, CA (US); Huaning NIU, San Jose, CA (US); Dawei ZHANG, Saratoga, CA (US)

(21) Appl. No.: 18/857,963

(22) PCT Filed: Apr. 25, 2022
(86) PCT No.: PCT/CN2022/089059

§ 371 Date: Oct. 18, 2024

(51) Int. Cl. H04W 24/10; H04L 5/00; H04W 72/0446; H04W 72/1268; H04W 72/232

(52) U.S. Cl. CPC H04W 24/10; H04L 5/0048; H04W 72/0446; H04W 72/1268; H04W 72/232

(57) ABSTRACT

A user equipment (UE) is configured to receive a dynamic time division duplexing (TDD) configuration comprising uplink (UL) transmissions for a serving cell having a first Physical Cell Identity (PCI), wherein the UL transmissions are scheduled for a same symbol as a reference signal (RS) for inter-cell Layer 1 reference signal received power (L1-RSRP) measurements transmitted by a second cell having a second PCI different from the first PCI and perform, during the scheduled symbol, one of (i) transmitting a UL signal to the serving cell or (ii) measuring the RS for the second cell, wherein the performing is based on a restriction.

### TECHNICAL FIELD

The present disclosure generally relates to communication, and in particular, to the user equipment operation for inter-cell L1-RSRP measurements.

### BACKGROUND INFORMATION

In Rel-17 of the 5G New Radio (NR) standards FeMIMO (Further Enhanced MIMO), inter-cell Layer 1 reference signal received power (L1-RSRP) measurements by a user equipment (UE) are introduced. L1-RSRP measurements may be determined from reference signal (RS) measurements including a system synchronization block (SSB) (PBCH-DMRS) (SS-RSRP) or a channel state information (CSI) reference signal (CSI-RS) (CSI-RSRP). However, when performing inter-cell measurements, the L1-RSRP measurements may be performed on cells with different Physical Cell Identities (PCI) from the current serving cell.

In time division duplexing (TDD) bands, dynamic TDD may be configured via Downlink Control Information (DCI) for the serving cell. The uplink (UL) slots for the serving cell may overlap with SSBs from the cell with a different PCI for inter-cell L1-RSRP measurements. The UE cannot transmit on the UL and receive the SSBs on the downlink (DL) simultaneously. Thus, UE behaviors need to be defined for the case when UL slots/symbols overlap with SSB from cells with different PCI.

### SUMMARY

Some exemplary embodiments are related to a processor of a user equipment (UE) configured to perform operations. The operations include receiving a dynamic time division duplexing (TDD) configuration comprising uplink (UL) transmissions for a serving cell having a first Physical Cell Identity (PCI), wherein the UL transmissions are scheduled for a same symbol as a reference signal (RS) for inter-cell Layer 1 reference signal received power (L1-RSRP) measurements transmitted by a second cell having a second PCI different from the first PCI and performing, during the scheduled symbol, one of (i) transmitting a UL signal to the serving cell or (ii) measuring the RS for the second cell, wherein the performing is based on a restriction.

Other exemplary embodiments are related to a user equipment (UE) having a transceiver configured to communicate with a base station and a processor communicatively coupled to the transceiver and configured to perform operations. The operations include receiving a dynamic time division duplexing (TDD) configuration comprising uplink (UL) transmissions for a serving cell having a first Physical Cell Identity (PCI), wherein the UL transmissions are scheduled for a same symbol as a reference signal (RS) for inter-cell Layer 1 reference signal received power (L1-RSRP) measurements transmitted by a second cell having a second PCI different from the first PCI and performing, during the scheduled symbol, one of (i) transmitting a UL signal to the serving cell or (ii) measuring the RS for the second cell, wherein the performing is based on a restriction.

Still further exemplary embodiments are related to a processor of a base station configured to perform operations. The operations include configuring a restriction for a user equipment (UE), wherein the L1-RSRP measurement configuration is related to the UE receiving a dynamic time division duplexing (TDD) configuration comprising uplink (UL) transmissions for a serving cell having a first Physical Cell Identity (PCI) and a reference signal (RS) for inter-cell Layer 1 reference signal received power (L1-RSRP) measurements from a second cell having a second PCI different from the first PCI, wherein the UL transmissions and the RS are scheduled for a same symbol and transmitting the restriction to the UE, wherein the restriction is related to a type of RS, wherein the type of RS comprises a system synchronization block (SSB) or a Channel State Information RS (CSI-RS).

Additional exemplary embodiments are related to a base station having a transceiver configured to communicate with a user equipment (UE) and a processor communicatively coupled to the transceiver and configured to perform operations. The operations include configuring a restriction for a user equipment (UE), wherein the L1-RSRP measurement configuration is related to the UE receiving a dynamic time division duplexing (TDD) configuration comprising uplink (UL) transmissions for a serving cell having a first Physical Cell Identity (PCI) and a reference signal (RS) for inter-cell Layer 1 reference signal received power (L1-RSRP) measurements from a second cell having a second PCI different from the first PCI, wherein the UL transmissions and the RS are scheduled for a same symbol and transmitting the restriction to the UE, wherein the restriction is related to a type of RS, wherein the type of RS comprises a system synchronization block (SSB) or a Channel State Information RS (CSI-RS).

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an exemplary signaling diagram for configuring the UE with scheduling restrictions and/or measurement restrictions related to L1-RSRP measurements according to various exemplary embodiments.

FIG. 5 shows an exemplary information element (IE) for the network to configure the UE with scheduling restrictions and/or measurement restrictions related to L1-RSRP measurements according to various exemplary embodiments.

### DETAILED DESCRIPTION

The exemplary embodiments may be further understood with reference to the following description and the related appended drawings, wherein like elements are provided with the same reference numerals. The exemplary embodiments relate to a user equipment (UE) applying scheduling restrictions and/or measurement restrictions related to inter-cell Layer 1 reference signal received power (L1-RSRP) measurements when UL transmissions for a serving cell overlap with a reference signal RS from a cell having a different Physical Cell Identity (PCI) from the serving cell.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate electronic component.

The exemplary embodiments are also described with regard to a 5G New Radio (NR) network. However, reference to a 5G NR network is merely provided for illustrative purposes. The exemplary embodiments may be utilized with any network that utilizes inter-cell L1-RSRP measurements. Therefore, the 5G NR network as described herein may represent any type of network that implements inter-cell L1-RSRP measurements.

In addition, as described above, the issues being resolved by the exemplary embodiments are related to time division duplexing (TDD) bands. It should be understood that the all the exemplary embodiments described herein are applicable to NR operation in both frequency range 1 (FR1) and frequency range 2 (FR2) of NR. Furthermore, the exemplary embodiments may be implemented in any network regardless of the frequency band.

The exemplary embodiments relate to scenarios where a serving cell configures a UE with UL transmissions for dynamic TDD using DCI. The UL transmissions are scheduled for a same symbol as when an RS for L1-RSRP measurement is to be received from a cell having a different PCI from the serving cell. The exemplary embodiments include the UE having scheduling restrictions such that the UE prioritizes the inter-cell L1-RSRP measurements or measurement restrictions such that the UE prioritizes the UL transmissions. Examples of these scheduling and measurement restrictions are described in greater detail below.

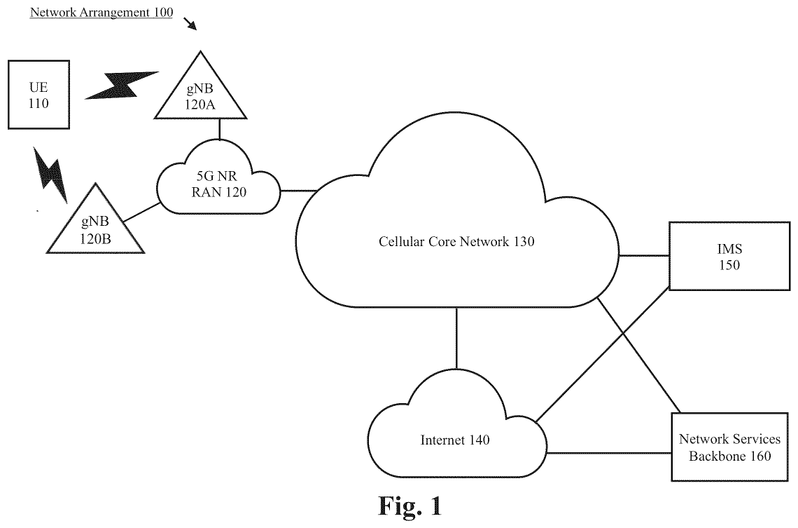

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR PAN 120. For example, as discussed above, the 5G NR PAN 120 may be associated with a particular cellular provider where the UE 110 and/or the user thereof has a contract and credential information (e.g., stored on a SIM card). Upon detecting the presence of the 5G NR PAN 120, the UE 110 may transmit the corresponding credential information to associate with the 5G NR PAN 120. More specifically, the UE 110 may associate with a specific base station, e.g., the gNB 120A.

In the exemplary network arrangement 100, two base stations, the gNB 120A and gNB 120B, are shown. In this example it may be considered that gNB 120A is the serving cell and gNB 120B is a neighbor cell that has a different PCI than the serving cell. However, those skilled in the art will understand that this arrangement is only exemplary and there may be many other types of arrangements where the UE 110 will make L1-RSRP measurements on cells with different PCIs. For example, the gNB 120A or gNB 120B may each include multiple cells that may have different PCIs. The gNB 120A or gNB 120B may have remotely located transmission and reception points (TRPs) that have different PCIs. There may be multiple neighbor cells for gNB 120A in addition to the gNB 120B. It should be understood that the exemplary embodiments may apply to any of these scenarios or any other scenario where the UE 110 is performing L1-RSRP measurements on cells with different PCIs.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

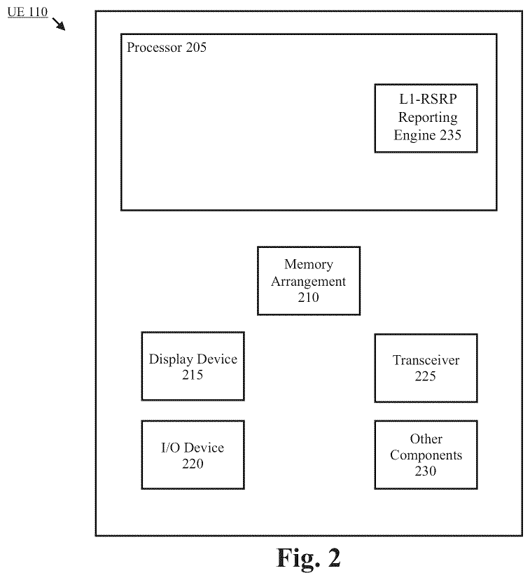

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a L1-RSRP reporting engine 235. The L1-RSRP reporting engine 235 may perform various operations, including but not limited to, implementing scheduling or measurement restrictions such that the UE prioritizes either the inter-cell L1-RSRP measurements or UL transmissions when scheduled for a same symbol as a RS for L1-RSRP measurement.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

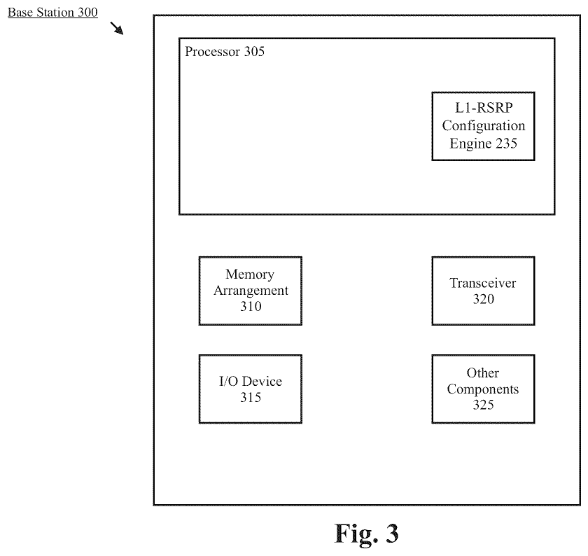

FIG. 3 shows an exemplary base station 300 according to various exemplary embodiments. The base station 300 may represent the gNB 120A, gNB 120B or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the base station 300. For example, the engines may include a L1-RSRP configuration engine 330. The L1-RSRP configuration engine 330 may perform various operations including but not limited to, configuring scheduling or measurement restrictions such that a UE prioritizes either the inter-cell L1-RSRP measurements or UL transmissions when scheduled for a same symbol as a RS for L1-RSRP measurement.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

As described above, the UE 110 may be configured to perform inter-cell L1-RSRP measurements. In some cases, the RS (e.g., SSBs, CSI-RS) for the L1-RSRP measurements that are transmitted by cells having different PCIs from the serving cell may overlap with an uplink (UL) transmissions for the serving cell. The UE 110 cannot simultaneously transmit to the serving cell and measure the L1-RSRP RS on the DL. To solve this issue, the exemplary embodiments provide various UE behaviors related to performing L1-RSRP measurements when such a conflict occurs.

In the current 3GPP standards, there are various conditions to be satisfied for performing inter-cell L1-RSRP measurements. These conditions include SSBs from the serving cell and the cell with the different PCI have the same center frequency, sub-carrier spacing (SCS) and system frame number (SFN) offset. In addition, during the predetermined time (e.g., 5 seconds) before L1-RSRP measurement is configured, the UE 110 has sent a valid Layer 3 (L3) measurement report for the cell with the different PCI. Furthermore, the timing offset between the serving cell and the cell with the different PCI are within the cyclic prefix (CP). In describing the exemplary embodiments, it will be considered that these conditions are satisfied and L1-RSRP measurements may be performed. However, it should be understood that the exemplary embodiments are not limited to scenarios where these specific conditions are used.

Initially, the UE 110 may include scheduling or measurement restrictions to handle L1-RSRP measurements based on SSBs transmitted by cells with different PCIs (e.g., gNB 120B) from the serving cell when these SSBs overlap with a UL transmission for the serving cell (e.g., gNB 120A). In some exemplary embodiments, the scheduling restrictions prioritize the SSB based L1-RSRP measurements. For example, a scheduling restriction may be defined such that the UE 110 is not required to transmit any UL signals (e.g., Physical Uplink Control Channel (PUCCH), Physical Uplink Shared Channel (PUSCH), Sounding Reference Signals (SRS)) to the serving cell in symbols where the UE 110 will receive SSB for L1-RSRP measurements from cells with different PCIs (e.g., gNB 120B) from the serving cell. Thus, in these exemplary embodiments, the UE 110 will always prioritize the SSB based L1-RSRP measurements.

In other exemplary embodiments, the measurement restrictions prioritize UL transmissions over the SSB based L1-RSRP measurements. However, because there are different types of UL transmissions, these exemplary measurement restrictions may prioritize all or some of the UL transmissions over the SSB based L1-RSRP measurements. In a first example, a measurement restriction may be defined such that the UE 110 is not required to perform SSB based L1-RSRP measurements on cells with a different PCI from the serving cell if the UL slots or symbols of any of PUCCH, PUSCH, or SRS overlap with the SSB of the cell with a different PCI. Thus, in this example, the UE 110 will always prioritize the UL transmissions.

In a second example, a measurement restriction may be defined such that the UE 110 is not required to perform SSB based L1-RSRP measurements on cells with a different PCI when the SSB overlaps with a UL signal that is triggered by DCI. An example of such a signal is an aperiodic SRS. Thus, in this example, the UE 110 will prioritize the UL transmission of aperiodic signals triggered by DCI but prioritize SSB based L1-RSRP measurements over all other types of UL transmissions.

In a third example, a measurement restriction may be defined such that the UE 110 is not required to perform SSB based L1-RSRP measurements on cells with different PCI when the SSB overlaps with one or more of different types of UL signals. For example, the UL signals may include PUCCH for Hybrid Automatic Repeat Request (HARQ) transmissions or Random Access Channel (RACH) transmissions. Thus, in this example, the UE 110 will prioritize defined UL transmissions but prioritize SSB based L1-RSRP measurements over all other types of UL transmissions. It should be understood that the example UL transmissions provided above are only examples. For example, only one of the transmissions listed above may be prioritized, additional UL transmissions may be prioritized, different UL transmissions may be prioritized, etc.

The following exemplary embodiments are related to the UE 110 including scheduling or measurement restrictions to handle CSI-RS based L1-RSRP measurements on cells with different PCIs (e.g., gNB 120B) from the serving cell when these CSI-RS overlap with a UL transmission for the serving cell (e.g., gNB 120A). In some exemplary embodiments, the scheduling restrictions prioritize the CSI-RS based L1-RSRP measurements over UL transmissions. However, since there are different types of CSI-RS, these exemplary scheduling restrictions may prioritize all or some of the CSI-RS based L1-RSRP measurements over the UL transmissions.

In a first example, a scheduling restriction may be defined such that the UE 110 is not required to transmit any UL signals (e.g., PUCCH, PUSCH, SRS) to the serving cell in symbols where the UE 110 will receive CSI-RS for L1-RSRP measurements from cells with different PCIs from the serving cell. Thus, in this example, the UE 110 will always prioritize the CSI-RS based L1-RSRP measurements.

In a second example, a scheduling restriction may be defined such that the UE 110 is not required to transmit PUCCH/PUSCH/SRS in symbols that aperiodic CSI-RS for L1-RSRP measurements are received. Thus, in this example, the UE 110 will always prioritize the aperiodic CSI-RS based L1-RSRP measurements but prioritize UL transmissions over other types of CSI-RS based L1-RSRP measurements.

In other exemplary embodiments, the measurement restrictions prioritize UL transmissions over the CSI-RS based L1-RSRP measurements. However, because there are different types of UL transmissions, these exemplary measurement restrictions may prioritize all or some of the UL transmissions over the CSI-RS based L1-RSRP measurements. In a first example, a measurement restriction may be defined such that the UE 110 is not required to perform CSI-RS based L1-RSRP measurements on cells with a different PCI from the serving cell if the UL slots or symbols of any of PUCCH, PUSCH, or SRS overlap with the CSI-RS of the cell with a different PCI. Thus, in this example, the UE 110 will always prioritize the UL transmissions.

In a second example, a measurement restriction may be defined such that the UE 110 is not required to perform CSI-RS based L1-RSRP measurements on cells with a different PCI when the CSI-RS overlaps with a UL signal that is triggered by DCI. An example of such a signal is an aperiodic SRS. Thus, in this example, the UE 110 will prioritize the UL transmission of aperiodic signals triggered by DCI but prioritize CSI-RS based L1-RSRP measurements over all other types of UL transmissions.

In a third example, a measurement restriction may be defined such that the UE 110 is not required to perform CSI-RS based L1-RSRP measurements on cells with different PCI when the CSI-RS overlaps with one or more of different types of UL signals. For example, the UL signals may include PUCCH for Hybrid Automatic Repeat Request (HARQ) transmissions or Random Access Channel (RACH) transmissions. Thus, in this example, the UE 110 will prioritize defined UL transmissions but prioritize CSI-RS based L1-RSRP measurements over all other types of UL transmissions. It should be understood that the example UL transmissions provided above are only examples. For example, only one of the transmissions listed above may be prioritized, additional UL transmissions may be prioritized, different UL transmissions may be prioritized, etc.

It should be understood that the UE 110 may be include any one of or both of the SSB based scheduling or measurement restrictions and/or the CRS-RS based scheduling or measurement restrictions.

In the exemplary embodiments, the UE 110 may be either preconfigured with the exemplary scheduling or measurement restrictions or receive the scheduling or measurement restrictions from the network. For example, when the UE 110 is preconfigured, the exemplary scheduling or measurement restrictions may be defined in the 3GPP standards and the UE 110 may be preconfigured to operate in a manner consistent with those scheduling or measurement restrictions. The below example will be described the UE 110 being configured by the network with the scheduling or measurement restrictions.

In other exemplary embodiments, the UE 110 may be configured with the scheduling or measurement restrictions based on network signaling to the UE 110. FIG. 4 shows an exemplary signaling diagram for configuring the UE with scheduling and/or measurement restrictions related to L1-RSRP measurements according to various exemplary embodiments. To continue with the example started above, it will be considered that the gNB 120A is the serving cell and the gNB 120B is the cell having the different PCI.

In 410, the serving cell gNB 120A may transmit scheduling or measurement restrictions to the UE 110. The scheduling or measurement restrictions may include any one or more of the restrictions described above. As described above, the scheduling and measurement restrictions may include a configuration related to prioritization rules in dynamic TDD when UL slots for a serving cell overlap with RS (e.g., SSB or CSI-RS) for L1-RSRP measurements on a cell with a different PCI than the serving cell. These prioritizations may include whether the L1-RSRP measurements should be prioritized or whether the UL transmissions should be prioritized. In some examples, the scheduling or measurement restrictions 410 may be applied at the UE level, e.g., applied to all UL signals or L1-RSRP measurements, or at the Physical layer (PHY) channel level, e.g., applied to certain UL signals or DL measurements. Various examples of these UE level and PHY channel level configurations were described above.

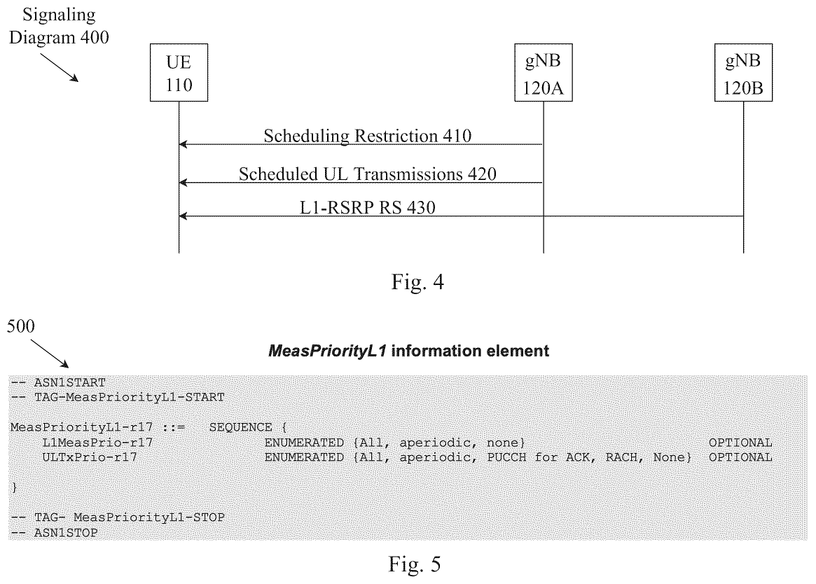

FIG. 5 shows an exemplary information element (IE) 500 for the network to configure the UE 110 with scheduling and/or measurement restrictions related to L1-RSRP measurements according to various exemplary embodiments. In this example, the IE 500 is named MeasPriorityL1. However, it should be understood that this name is only exemplary. This IE 500 may be used by the network to signal the UE 110 the scheduling or measurement restrictions 410. As shown in FIG. 5, the measurement priority may be set to the UL transmissions or the L1-RSRP measurements as described above. The MeasPriorityL1 IE 500 may be reported in Radio Resource Control (RRC) signaling, Medium Access Control (MAC) signaling or any other manner of signaling between the UE 110 and the gNB 120A.

Returning to the signaling 400 of FIG. 4, after receiving the scheduling or measurement restrictions 410, the UE 110 will have the proper scheduling or measurement restrictions. In 420, the UE may receive a dynamic time division duplexing (TDD) configuration comprising uplink (UL) transmissions configured for the serving cell gNB 120A. These UL transmissions 420 may overlap with the L1-RSRP RS transmissions 430 of the cell with a different PCI (gNB 120B). The UE 110 operation will depend on the scheduling or measurement restrictions 410. That is, the UE 110 will either perform the L1-RSRP measurements for the cell with a different PCI or perform UL transmissions as described above.

### EXAMPLES

In a first example, a method performed by a user equipment (UE), comprising receiving a dynamic time division duplexing (TDD) configuration comprising uplink (UL) transmissions for a serving cell having a first Physical Cell Identity (PCI), wherein the UL transmissions are scheduled for a same symbol as a reference signal (RS) for inter-cell Layer 1 reference signal received power (L1-RSRP) measurements transmitted by a second cell having a second PCI different from the first PCI, and performing, during the scheduled symbol, one of (i) transmitting a UL signal to the serving cell or (ii) measuring the RS for the second cell, wherein the performing is based on a restriction.

In a second example, the method of the first example, wherein the RS comprises a system synchronization block (SSB).

In a third example, the method of the second example, wherein the restriction is a scheduling restriction comprising prioritizing L1-RSRP measurements over UL transmissions such that the UE measures the SSB for the second cell in the scheduled symbol.

In a fourth example, the method of the second example, wherein the restriction is a measurement restriction comprising prioritizing UL transmissions over L1-RSRP measurements such that the UE transmits the UL signal to the serving cell in the scheduled symbol.

In a fifth example, the method of the second example, wherein the measurement restriction comprises prioritizing UL transmissions triggered by Downlink Control Information (DCI) over L1-RSRP measurements such that the UE transmits the UL signal to the serving cell in the scheduled symbol when the UL signal was triggered by DCI and the UE measures the SSB for the second cell in the scheduled symbol when the UL signal is not triggered by DCI.

In a sixth example, the method of the second example, wherein the measurement restriction comprises prioritizing defined UL transmissions over L1-RSRP measurements such that the UE transmits the UL signal to the serving cell in the scheduled symbol when the UL signal is one of the defined UL transmissions and the UE measures the SSB for the second cell in the scheduled symbol when the UL signal is not one of the defined UL transmissions.

In a seventh example, the method of the sixth example, wherein the defined UL transmissions comprise a Physical Uplink Control Channel (PUCCH) for a Hybrid Automatic Repeat Request (HARQ) transmission or a Random Access Channel (RACH) transmission.

In an eighth example, the method of the first example, wherein the RS comprises a Channel State Information RS (CSI-RS).

In a ninth example, the method of the eighth example, wherein the restriction comprises a scheduling restriction comprising prioritizing L1-RSRP measurements over UL transmissions such that the UE measures the CSI-RS for the second cell in the scheduled symbol.

In a tenth example, the method of the eighth example, wherein the restriction is a scheduling restriction comprising prioritizing aperiodic L1-RSRP measurements over UL transmissions such that the UE measures the CSI-RS for the second cell in the scheduled symbol when the CSI-RS are aperiodic and the UE transmits the UL signal to the serving cell in the scheduled symbol when the CSI-RS are not aperiodic.

In an eleventh example, the method of the eighth example, wherein the restriction is a measurement restriction comprising prioritizing UL transmissions over L1-RSRP measurements such that the UE transmits the UL signal to the serving cell in the scheduled symbol.

In a twelfth example, the method of the eighth example, wherein the restriction is a measurement restriction comprising prioritizing UL transmissions triggered by Downlink Control Information (DCI) over L1-RSRP measurements such that the UE transmits the UL signal to the serving cell in the scheduled symbol when the UL signal was triggered by DCI and the UE measures the CSI-RS for the second cell in the scheduled symbol when the UL signal is not triggered by DCI.

In a thirteenth example, the method of the eighth example, wherein the restriction is a measurement restriction comprising prioritizing defined UL transmissions over L1-RSRP measurements such that the UE transmits the UL signal to the serving cell in the scheduled symbol when the UL signal is one of the defined UL transmissions and the UE measures the CSI-RS for the second cell in the scheduled symbol when the UL signal is not one of the defined UL transmissions.

In a fourteenth example, the method of the thirteenth example, wherein the defined UL transmissions comprise a Physical Uplink Control Channel (PUCCH) for a Hybrid Automatic Repeat Request (HARQ) transmission or a Random Access Channel (RACH) transmission.

In a fifteenth example, the method of the first example, wherein the restriction is preconfigured in the UE.

In a sixteenth example, the method of the first example, further comprising receiving the restriction from the serving cell.

In a seventeenth example, a processor of a user equipment (UE) configured to perform any of the operations of the first through sixteenth examples.

In an eighteenth example, a user equipment (UE) comprising a transceiver configured to communicate with a base station and a processor communicatively coupled to the transceiver and configured to perform any of the operations of the first through sixteenth examples.

In a nineteenth example, a method performed by a base station, comprising configuring a restriction for a user equipment (UE), wherein the L1-RSRP measurement configuration is related to the UE receiving a dynamic time division duplexing (TDD) configuration comprising uplink (UL) transmissions for a serving cell having a first Physical Cell Identity (PCI) and a reference signal (RS) for inter-cell Layer 1 reference signal received power (L1-RSRP) measurements from a second cell having a second PCI different from the first PCI, wherein the UL transmissions and the RS are scheduled for a same symbol and transmitting the restriction to the UE.

In a twentieth example, the method of the nineteenth example, wherein the restriction is related to a type of RS, wherein the type of RS comprises a system synchronization block (SSB) or a Channel State Information RS (CSI-RS).

In a twenty first example, the method of the nineteenth example, wherein the restriction is included in an information element (IE).

In a twenty second example, the method of the twenty first example, wherein the IE is transmitted in a Radio Resource Control (RRC) message or a Medium Access Control—Control Element (MAC—CE).

In a twenty third example, the method of the nineteenth example, wherein the restriction is a UE level scheduling restriction that prioritizes all L1-RSRP measurements over UL transmissions.

In a twenty fourth example, the method of the nineteenth example, wherein the restriction is a UE level measurement restriction that prioritizes all UL transmissions over L1-RSRP measurements.

In a twenty fifth example, the method of the nineteenth example, wherein the restriction is a physical channel level scheduling restriction that prioritizes a subset of L1-RSRP measurements over all UL transmissions

In a twenty sixth example, the method of the nineteenth example, wherein the restriction is a physical channel level measurement restriction that prioritizes a subset of UL transmissions over all L1-RSRP measurements.

In a twenty seventh, a processor of a base station configured to perform any of the operations of the nineteenth through twenty sixth examples.

In a twenty eighth, a base station comprising a transceiver configured to communicate with a user equipment (UE) and a processor communicatively coupled to the transceiver and configured to perform any of the operations of the nineteenth through twenty sixth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to perform operations comprising:
receiving a dynamic time division duplexing (TDD) configuration comprising uplink (UL) transmissions for a serving cell having a first Physical Cell Identity (PCI), wherein the UL transmissions are scheduled for a same symbol as a reference signal (RS) for inter-cell Layer 1 reference signal received power (L1-RSRP) measurements transmitted by a second cell having a second PCI different from the first PCI; and
performing, during the scheduled symbol, one of (i) transmitting a UL signal to the serving cell or (ii) measuring the RS for the second cell, wherein the performing is based on a restriction.

2. The processor of claim 1, wherein the RS comprises a system synchronization block (SSB).

3. The processor of claim 2, wherein the restriction is a scheduling restriction comprising prioritizing L1-RSRP measurements over UL transmissions such that the UE measures the SSB for the second cell in the scheduled symbol.

4. The processor of claim 2, wherein the restriction is a measurement restriction comprising prioritizing UL transmissions over L1-RSRP measurements such that the UE transmits the UL signal to the serving cell in the scheduled symbol.

5. The processor of claim 2, wherein the measurement restriction comprises prioritizing UL transmissions triggered by Downlink Control Information (DCI) over L1-RSRP measurements such that the UE transmits the UL signal to the serving cell in the scheduled symbol when the UL signal was triggered by DCI and the UE measures the SSB for the second cell in the scheduled symbol when the UL signal is not triggered by DCI.

6. The processor of claim 2, wherein the measurement restriction comprises prioritizing defined UL transmissions over L1-RSRP measurements such that the UE transmits the UL signal to the serving cell in the scheduled symbol when the UL signal is one of the defined UL transmissions and the UE measures the SSB for the second cell in the scheduled symbol when the UL signal is not one of the defined UL transmissions, wherein the defined UL transmissions comprise a Physical Uplink Control Channel (PUCCH) for a Hybrid Automatic Repeat Request (HARQ) transmission or a Random Access Channel (RACH) transmission.

7. The processor of claim 1, wherein the RS comprises a Channel State Information RS (CSI-RS).

8. The processor of claim 7, wherein the restriction comprises a scheduling restriction comprising prioritizing L1-RSRP measurements over UL transmissions such that the UE measures the CSI-RS for the second cell in the scheduled symbol.

9. The processor of claim 7, wherein the restriction is a scheduling restriction comprising prioritizing aperiodic L1-RSRP measurements over UL transmissions such that the UE measures the CSI-RS for the second cell in the scheduled symbol when the CSI-RS are aperiodic and the UE transmits the UL signal to the serving cell in the scheduled symbol when the CSI-RS are not aperiodic.

10. The processor of claim 7, wherein the restriction is a measurement restriction comprising prioritizing UL transmissions over L1-RSRP measurements such that the UE transmits the UL signal to the serving cell in the scheduled symbol.

11. The processor of claim 7, wherein the restriction is a measurement restriction comprising prioritizing UL transmissions triggered by Downlink Control Information (DCI) over L1-RSRP measurements such that the UE transmits the UL signal to the serving cell in the scheduled symbol when the UL signal was triggered by DCI and the UE measures the CSI-RS for the second cell in the scheduled symbol when the UL signal is not triggered by DCI.

12. The processor of claim 7, wherein the restriction is a measurement restriction comprising prioritizing defined UL transmissions over L1-RSRP measurements such that the UE transmits the UL signal to the serving cell in the scheduled symbol when the UL signal is one of the defined UL transmissions and the UE measures the CSI-RS for the second cell in the scheduled symbol when the UL signal is not one of the defined UL transmissions, wherein the defined UL transmissions comprise a Physical Uplink Control Channel (PUCCH) for a Hybrid Automatic Repeat Request (HARQ) transmission or a Random Access Channel (RACH) transmission.

13. The processor of claim 1, wherein the restriction is preconfigured in the UE.

14. The processor of claim 1, further comprising:
receiving the restriction from the serving cell.

15. A processor of a base station configured to perform operations comprising:
configuring a restriction for a user equipment (UE), wherein the L1-RSRP measurement configuration is related to the UE receiving a dynamic time division duplexing (TDD) configuration comprising uplink (UL) transmissions for a serving cell having a first Physical Cell Identity (PCI) and a reference signal (RS) for inter-cell Layer 1 reference signal received power (L1-RSRP) measurements from a second cell having a second PCI different from the first PCI, wherein the UL transmissions and the RS are scheduled for a same symbol; and
transmitting the restriction to the UE, wherein the restriction is related to a type of RS, wherein the type of RS comprises a system synchronization block (SSB) or a Channel State Information RS (CSI-RS).

16. The processor of claim 15, wherein the restriction is included in an information element (IE), wherein the IE is transmitted in a Radio Resource Control (RRC) message or a Medium Access Control—Control Element (MAC—CE).

17. The processor of claim 15, wherein the restriction is a UE level scheduling restriction that prioritizes all L1-RSRP measurements over UL transmissions.

18. The processor of claim 15, wherein the restriction is a UE level measurement restriction that prioritizes all UL transmissions over L1-RSRP measurements.

19. The processor of claim 15, wherein the restriction is a physical channel level scheduling restriction that prioritizes a subset of L1-RSRP measurements over all UL transmissions

20. The processor of claim 15, wherein the restriction is a physical channel level measurement restriction that prioritizes a subset of UL transmissions over all L1-RSRP measurements.
